(19) United States
(12) Patent Application Publication
(10) Pub. No.: US 2021/0199774 A1
(43) Pub. Date: Jul. 1, 2021

(54) METHOD AND SYSTEM OF ADJUSTING PRISM LENS IN LIDAR SYSTEM

(71) Applicant: Voyager (HK) Co., Ltd., Beijing (CN)

(72) Inventors: Anan Pan, Mountain View, CA (US); Henghui Jiang, Mountain View, CA (US)

(73) Assignee: Voyager (HK) Co., Ltd., Beijing (CN)

(21) Appl. No.: 16/731,985

(22) Filed: Dec. 31, 2019

(51) Int. Cl. G01S 7/481; G02B 26/08; G02B 26/10

(52) U.S. Cl. CPC G01S 7/4817; G02B 5/04; G02B 26/108; G02B 26/0883

(57) ABSTRACT

A method and a system of adjusting a prism lens in a LiDAR system are provided. An exemplary method may include fitting a turning wheel on a half circle notch on a base plate onto which the prism lens is to be placed. The method may also include fitting a spring on a tail of the turning wheel. The method may further include placing the prism lens onto the base plate and turning the turning wheel until it engages with the prism lens. Additionally, the method may include fine adjusting the turning wheel to move the prism lens to a target location and then securing the prism lens at the target location.

### TECHNICAL FIELD

The present disclosure relates to a Light Detection and Ranging (LiDAR) system, and more particularly, to a method and a system of adjusting a prism lens in a LiDAR system.

### BACKGROUND

A LiDAR is a surveying system that measures distance to a target by illuminating the target with laser light and measuring the reflected light with a sensor. Differences in laser return times and wavelengths can then be used to make digital 3-D representations of the target. The technology is quite similar to that of RADAR (radio-wave navigation used by ships and planes) and SONAR (underwater object detection and navigation using sound, mainly used by submarines) which both use the principle of reflection of waves for object detection and distance estimation. However, while RADAR is based on radio waves and SONAR is based on sounds, LiDAR is based on light beams (laser). Because using a narrow laser beam as the incident light can map physical features with very high resolution, a LiDAR system is particularly suitable for applications such as sensing in autonomous driving and/or high-definition map surveys.

Lidar uses ultraviolet, visible, or near infrared light to image objects. A narrow laser beam can map physical features with very high resolutions. Among the various types of laser techniques used for LiDARs, microelectromechanical systems (MEMS) are associated with a small form factor that provides many of the same cost benefits as solid-state lasers. In a MEMS LiDAR system, a prism lens is used to focus the laser on a MEMS sensor. The location of the prism lens is very important because it decides the refraction angles and determines where light focuses after the prism lens.

Traditionally, base plates have been individually designed and manufactured with lens holding slots located at various locations slightly different from each other, such that when lenses are inserted into the slots, they will be at desired distances from the MEMS sensors. The approach significantly increases manufacturing cost. Alternatively, a uniform base plate may be used to hold the prism lens, and fixtures, tools and/or screws are used to adjust the location of the prism lenses in order to achieve the desired distances. However, this approach is labor intensive and inaccurate as manual adjustment of the lens location can be oftentimes imprecise. Therefore, the existing prism lens fitting mechanisms are inconvenient, inefficient and sometimes inaccurate.

Embodiments of the present disclosure provide a method and a system that address the aforementioned shortcomings.

### SUMMARY

Embodiments of the disclosure provide a method of adjusting a prism lens in a LiDAR system in which the prism lens focuses light on a MEMS sensor. An exemplary method may include fitting a turning wheel on a half circle notch on a base plate onto which the prism lens is to be placed. The method may also include fitting a spring on a tail of the turning wheel. The method may further include placing the prism lens onto the base plate and turning the turning wheel until it engages with the prism lens. Additionally, the method may include fine adjusting the turning wheel to move the prism lens to a target location and then securing the prism lens at the target location.

In some embodiments, the method also includes fixing the prism lens to a prism lens holder, for example, by gluing the prism lens to the prism lens holder. In some embodiments, the prism lens is placed onto the base plate together with the prism lens holder, for example, using at least one guiding pin attached on the base plate as guidance. In some alternative embodiments, the prism lens holder is part of the base plate.

In some embodiments, the method also includes fitting a cover plate on the base plate. For example, the cover plate is fitted on the base plate with screws. The prism lens holder is positioned by the at least one guiding pin and the cover plate. In some embodiments, the prism lens is secured at the target location by applying glues in gaps between the prism lens holder and the base plate and the cover plate. The target location of the prism lens enables the prism lens to focus light onto a sensor.

Embodiments of the disclosure also provide a system of adjusting a prism lens in a LiDAR system in which the prism lens focuses light on a MEMS sensor. An exemplary system may include a base plate, a prism lens placed onto the base plate, a turning wheel being fitted on a half circle notch on the base plate, and a spring being fitted on a tail of the turning wheel. The turning wheel may be configured to fine adjust the location of the prism lens to a target location that enables the prism lens to focus the light onto the MEMS sensor.

In some embodiments, the system may further include a prism lens holder and the prism lens is fixed, for example, glued, to the prism lens holder. In some embodiments, the prism lens is placed onto the base plate together with the prism lens holder. In some alternative embodiments, the prism lens holder is part of the base plate. In some embodiments, the base plate may include at least one guiding pin attached thereon for guiding the placement of the prism lens and the prism lens holder onto the base plate.

In some embodiments, the system may further include a cover plate fitted onto the base plate with screws, and the prism lens holder is positioned by the at least one guiding pin and the cover plate. In some embodiments, the prism lens is secured at the target location by applying glues in gaps between the prism lens holder and the base plate and the cover plate.

Embodiments of the disclosure further provide a LiDAR system. An exemplary LiDAR system may include a MEMS sensor and a prism lens focusing light on the MEMS sensor. The LiDAR system may also include a system of adjusting a location of the prism lens. The system of adjusting a location of the prism lens may include a base plate, the prism lens being placed onto the base plate, a turning wheel being fitted on a half circle notch on the base plate, and a spring being fitted on a tail of the turning wheel. The turning wheel may be configured to fine adjust the location of the prism lens to a target location that enables the prism lens to focus the light onto the MEMS sensor.

It is to be understood that both the foregoing general description and the following detailed description are exemplary and explanatory only and are not restrictive of the invention, as claimed.

### BRIEF DESCRIPTION OF THE DRAWINGS

In order to more clearly explain the technical solution of the embodiment of the present invention, the following will be a brief introduction of the drawings to be used in the embodiment. It is obvious that the drawings in the following description are some embodiments of the present invention, and for a person having ordinary skill in the art, other drawings can also be obtained based on these drawings without involving inventive skills.

FIG. 1 illustrates a block diagram of an exemplary implementation of LiDAR system, according to embodiments of the disclosure.

FIG. 2 illustrates a diagram illustrating how an exemplary prism lens works in a transmitter of a LiDAR system, according to embodiments of the disclosure.

FIG. 3 illustrates an exemplary isometric view of a system of adjusting a location of a prism lens, according to embodiments of the disclosure.

FIG. 4 illustrate a sectional view of the system of adjusting a location of a prism lens as shown in FIG. 3, according to embodiments of the disclosure.

FIG. 5 illustrates a top plane view of the system of adjusting a location of a prism lens as shown in FIG. 3, according to embodiments of the disclosure.

FIG. 6 illustrates a flowchart of an exemplary method of adjusting a location of a prism lens, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

A LiDAR system may be mounted on a mobile object, such as a vehicle, and configured to capture data as the object moves along a trajectory. For example, a transmitter of the LiDAR system is configured to scan the surrounding and acquire point clouds. The LiDAR system measures distance to a target by ilium g the pulsed laser light and measuring the reflected pulses with a receiver. The laser light used by the LiDAR system may be ultraviolet, visible, or near infrared. The data captured by the LiDAR system may be point clouds. As the object moves along a trajectory, the LiDAR system may continuously emit/scan laser beams and receive returned laser beams.

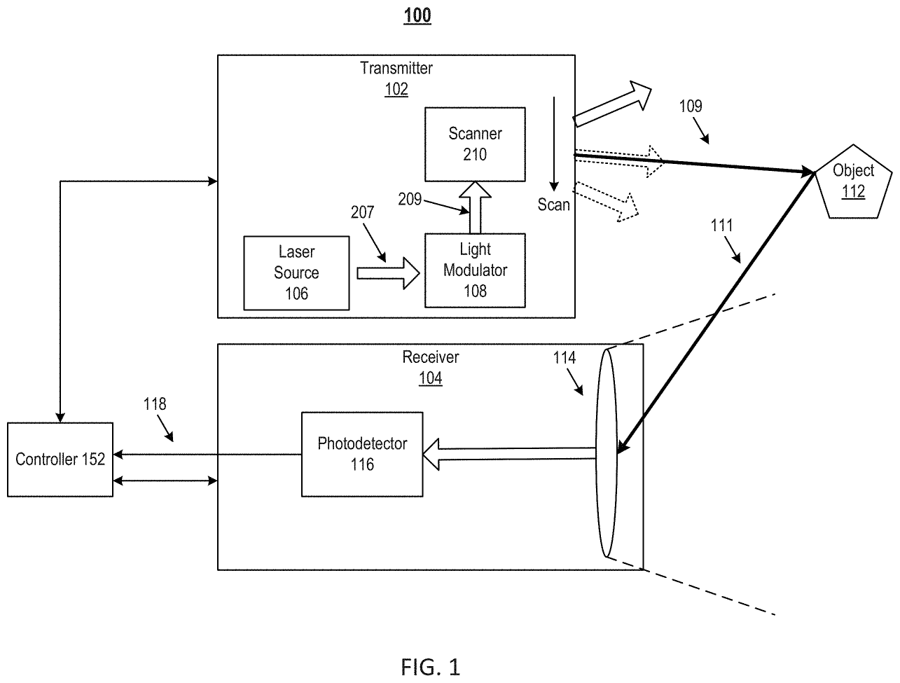

FIG. 1 illustrates a block diagram of an exemplary implementation of LiDAR system 100, according to embodiments of the disclosure. As shown in FIG. 1, LiDAR system 100 has a transmitter 102 for emitting a laser beam 109 and a receiver 104 for collecting data that include a returned laser beam 111 reflected by an object 112. Transmitter 202 may include any suitable light source that emits laser beam 109 outwardly into the surroundings of LiDAR system 100. In some embodiments, laser beam 109 includes a pulsed laser signal with a scanning angle, as illustrated in FIG. 1.

Transmitter 102 may include any suitable components for generating laser beam 109 of a desired wavelength and/or intensity. For example, transmitter 102 may include a laser source 106 that generates a native laser beam 107 in the ultraviolet, visible, or near infrared wavelength range. Transmitter 102 may also include a light modulator 108 that collimates native laser beam 107 to generate laser beam 109. Scanner 110 can scan laser beam 109 at a desired scanning angle and a desired scanning rate. Each laser beam 109 can forma scanning point on a surface facing transmitter 102 and at a distance from LiDAR system 100. Laser beam 109 may be incident on object 112, reflected back, and collected by a lens 114. Object 112 may be made of a wide range of materials including, for example, live objects, non-metallic objects, rocks, rain, chemical compounds, aerosols, clouds and even single molecules. The wavelength of laser beam 109 may vary based on the composition of object 112. In some embodiments of the present disclosure, scanner 110 may include optical components (e.g., lenses, mirrors) that can focus pulsed laser light into a narrow laser beam to increase the scan resolution. For example, prism lenses may be included to focus the light beams. The location of prism lens is important, requiring the accuracy when it is placed on the sitting plate. It oftentimes needs to be adjustable so that the light beam can be focused on sensors such as a MEMS sensor.

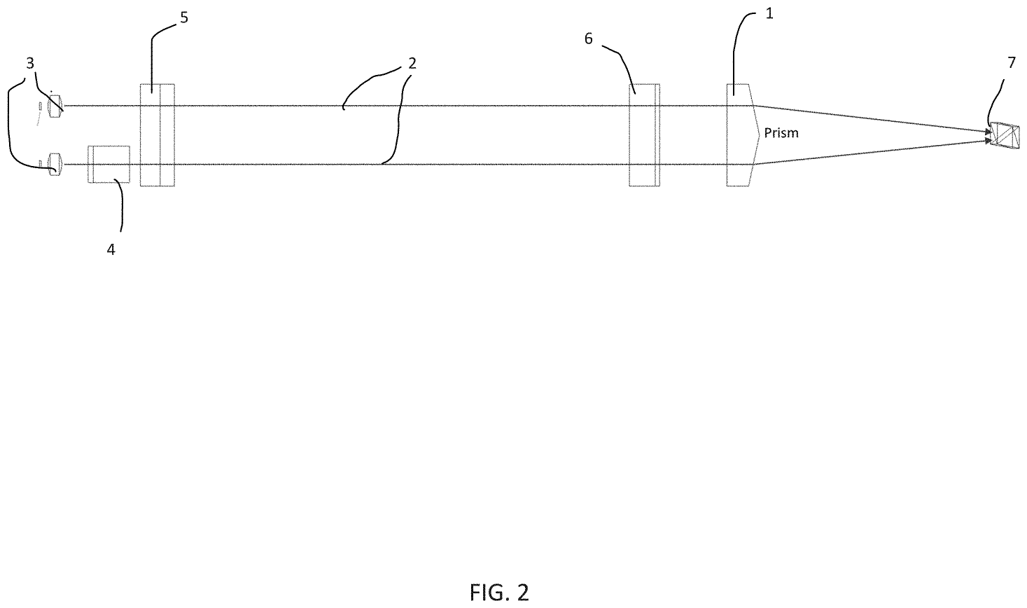

Receiver 104 may be configured to detect returned laser beam 111 (e.g., returned signals) reflected from object 112. Upon contact, laser light can be reflected by object 112 via backscattering, such as Rayleigh scattering, Mie scattering, Raman scattering, and fluorescence. Receiver 104 can collect returned laser beam 111 and output electrical signal indicative of the intensity of returned laser beam 111. As illustrated in FIG. 2A, receiver 104 may include lens 114 and a photodetector (or photodetector array) 116. Lens 114 may be configured to collect light from a respective direction in its field of view (FOV).

Photodetector 116 may be configured to detect returned laser beam 111 reflected by object 112. Photodetector 116 may convert the laser light (e.g., returned laser beam 111) collected by lens 114 into a receiver signal 218 (e.g., a current or a voltage signal). Receiver signal 118 may be generated when photons are absorbed in photodiode 116. Receiver signal 118 may be transmitted to a data processing unit, e.g., controller 152 of LiDAR system 100, to be processed and analyzed. Controller 152 may be configured to control transmitter 102 and/or receiver 104 to perform detection/sensing operations.

An aspect of the disclosure is directed to a method of adjusting a prism lens in a LiDAR system, such as LiDAR system 100, in which the prism lens focuses light on a MEMS sensor. According to this method, a turning wheel may be fitted on a half circle notch on a base plate onto which the prism lens is to be placed. A spring may be fitted on a tail of the turning wheel. After the prism lens is placed onto the base plate, the turning wheel may be turned until it engages with the prism lens to move the prism lens to a target location. The prism lens may be then secured at the target location. In this way, the location of the prism lens can be simply and accurately adjusted by fine turning the turning wheel without the need for any tools and/or screws.

FIG. 2 is a diagram illustrating how a prism lens works in a transmitter of a LiDAR system. As shown in FIG. 2, the prism lens 1 receives light beams 2 from light sources 3 after the light beams 2 passing through filter lenses 4, 5, and 6, and then focuses the light beams 2 on to a sensor 7 in a LiDAR system.

Prism lens 1 may be a transparent optical element with flat, polished surfaces that refract light. At least two of the flat surfaces have an angle between them. The exact angle between the surfaces decides the refraction angle and can be selected depending on the application. In some embodiments, the geometrical shape of prism lens 11 is that of a triangular prism with a triangular base and rectangular sides. Prism lens 1 can be made from any material that is transparent to the wavelengths for which they are designed. Typical materials include glass, plastic, and fluorite.

In some embodiments, sensor 7 may be a MEMS sensor. MEMS can be made up of components between 1 and 100 micrometers in size (i.e., 0.001 to 0.1 mm), and MEMS devices generally range in size from 20 micrometres to a millimeter (i.e., 0.02 to 1.0 mm). They usually consist of a central unit that processes data (an integrated circuit chip such as microprocessor) and several components that interact with the surroundings (such as microsensors).

Refraction angle of prism lens 1 decides where the light beams 2 focus after the prism lens 1. Thus, the location of the prism lens 1 is very important and it needs to be able to be accurately adjusted so that the light beams 2 can be precisely focused on the MEMS 7. Focusing light beams 2 into a narrow laser beam onto sensor 7 can increase the scan resolution of the LiDAR system.

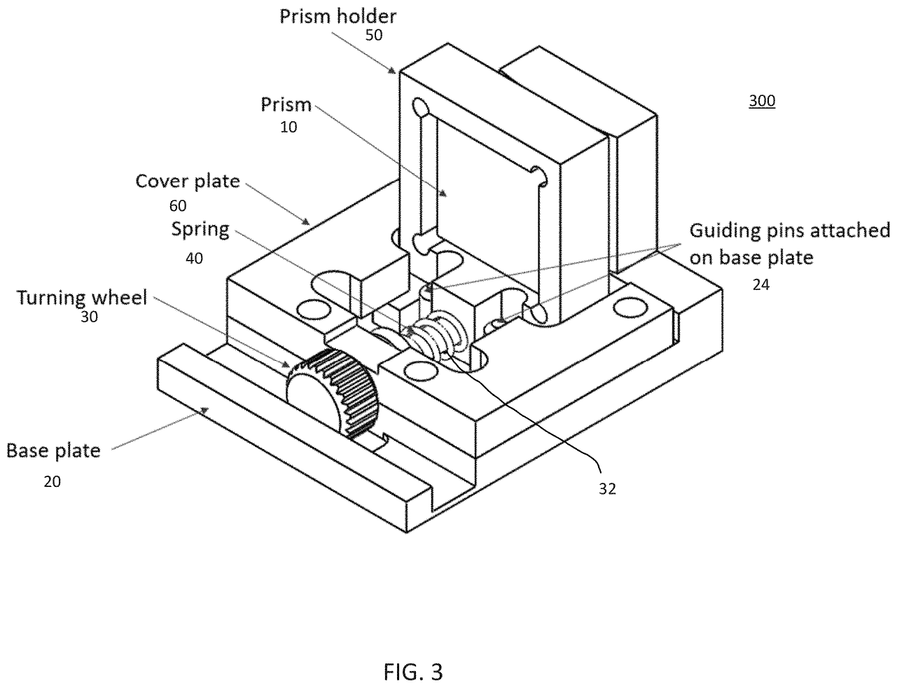

FIGS. 3-5 illustrate an exemplary system 300 of adjusting a location of a prism lens in a LiDAR system in which the prism lens focuses light on a MEMS sensor, according to embodiments of the disclosure. By incorporating an adjustable mechanism, the disclosed system can adjust the location of the prism lens (e.g., prism lens 1) effectively and conveniently without using any tools. In some embodiments, the adjustable mechanism may be a wheeled mechanism as shown in FIGS. 3-5. The wheeled mechanism is particularly easy to operate. However, other similar adjustable mechanisms can also be implemented to achieve the same function of system 300.

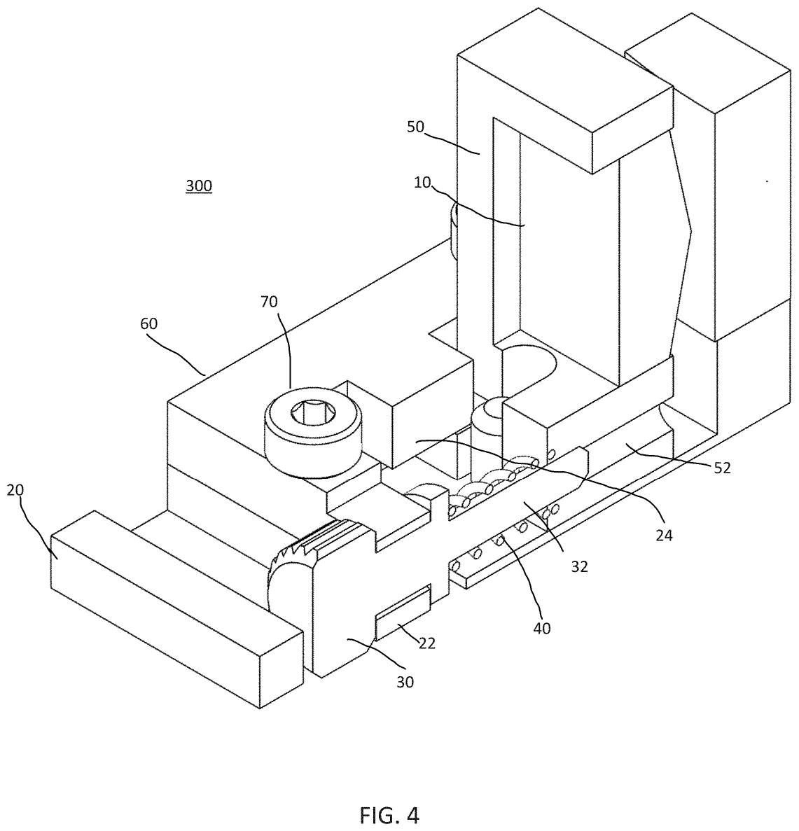

FIG. 3 illustrates an exemplary isometric view of the system of adjusting a location of a prism lens (system 300). As shown in in FIG. 3, system 300 may include a base plate 20, a prism lens 10 placed onto the base plate 20, a turning wheel 30 being fitted on a half circle notch 22 (see FIG. 4) on the base plate 20, and a spring 40.

The system 300 may further include a prism lens holder 50. The prism lens 10 may be fixed to the prism lens holder 50. As an example, the prism lens 10 may be glued to the prism lens holder 50. The prism lens holder 50 may be a separate part. In this case, the prism lens 10 may be placed onto the base plate 20 together with the prism lens holder 50. Alternatively, the prism lens holder 50 may also be formed as an integral part of the base plate 20.

The base plate 20 may further include at least one guiding pin 24 (two are shown) attached thereon for guiding the placement of the prism lens 10 and the prism lens holder 50 onto the base plate 20.

The system 100 may additionally include a cover plate 60 fitted onto the base plate 20. For example, the cover plate 60 may be fitted onto the base plate 20 with screws 70 (see FIG. 4). The at least one guiding pin 24 and the cover plate 60 may be used to help the placement and positioning of the prism lens holder 50 together with the prism lens 10.

Combination of turning wheel 30 and spring 40 may be configured to fine adjust the location of the prism lens 10 to a target location. In some embodiments, turning wheel 30 may include a cap that can be rotated/turned by a user and a tail 32. Spring 40 may be fitted on an exposed part of tail 32 of the turning wheel 30. In some embodiments, the target location of the prism lens is a location that enables the prism lens to focus the light beams onto a desired object, such as sensor 7.

FIG. 4 illustrates a sectional view of the system of adjusting a location of a prism lens (system 300) as shown in FIG. 3. As shown in FIG. 4, a threaded hole 52 may be formed in the prism lens holder 50. In some embodiments, tail 32 may be threaded. By turning the cap of turning wheel 30, the tail 32 of the turning wheel 30 may be threaded into the threaded hole 52. Movement of tail 32 inward of threaded hole 52 tends to shorten the exposed part of tail 32 on which spring 40 is fitted and compresses spring 40 accordingly. Spring 40 in turn pushes prism lens holder 50 forward. Therefore, the location of prism lens holder 50 with the prism lens 10 fixed thereon is adjusted in response to turning of turning wheel 30.

In some embodiments, the turning ratio may be adjusted according to the precision needed for the adjustment. As used herein, turning ratio refers to the ratio between the distance the prism lens holder 50 moves and the number of turns of the cap and. For example, the turning ratio may be adjusted by changing the threading of turning wheel 30. In some embodiments, the turning ratio may be 1 mm per turn, 0.1 mm per turn, 10 μm per turn, 1 μm per turn, or any suitable value as determined by the particular application. By using a smaller turning ratio, the location of the prism lens may be adjusted with a higher precision.

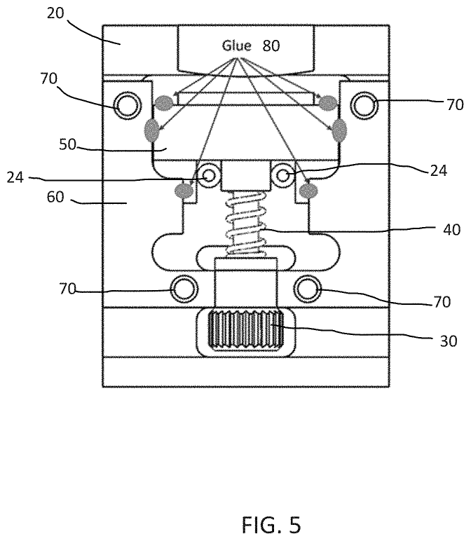

FIG. 5 illustrates a top plane view of the system of adjusting a location of a prism lens (system 300) as shown in FIG. 3. As shown in FIG. 5, after the prism lens 10 is fine adjusted to its target location, the metal parts are secured, followed by the prism lens holder 50 with the prism lens 10 (not shown in FIG. 5) fixed therein being secured at the target location. In some embodiments, the prism lens holder 50 may be secured by applying filler 80 in gaps between the prism lens holder 50 and the base plate 20 and the cover plate 60. In general, filler 80 is used to fill up the space between the prism lens holder 50 and the base plate 20 and the cover plate 60, so that prism lens holder 50 is fixed on base plate 20. In other words, prism lens holder, and thus prism lens 10 fixed thereon, stays at the target location. In some embodiments, filler 80 may be a material between solid and liquid states, such as glue, to provide non-rigid filling. Glue filling helps fill the entire space between the prism lens holder 50 and the base plate 20 and the cover plate 60 without gap to prevent further movement of the prism lens holder 50. In some embodiments, filler 80 may be selected as a material having a low coefficient of thermal expansion, so that filler 80 does not expand or contract significantly with temperature change.

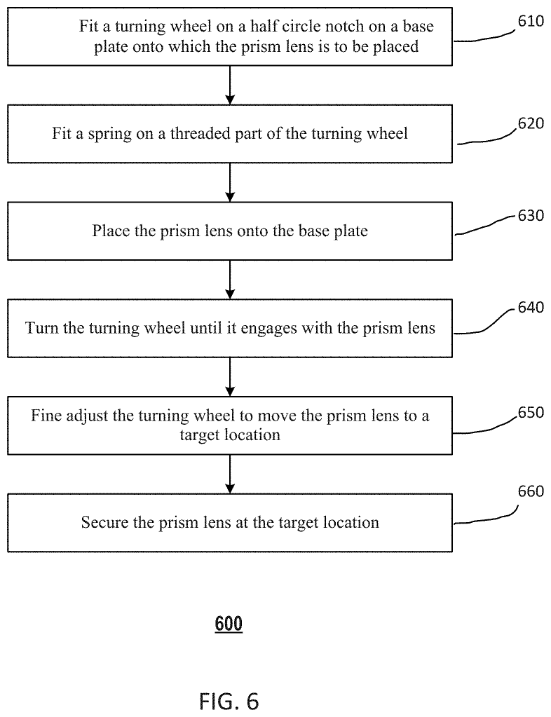

FIG. 6 illustrates a flowchart of an exemplary method 600 of adjusting a location of a prism lens, according to embodiments of the disclosure. Method 600 may be implemented during the manufacture of LiDAR systems. For example, method 600 may be performed by a machine, a worker or a robot at a LiDAR factory. Method 600 may include steps 610-660 as described below. It is to be appreciated that some of the steps may be optional to perform the disclosure provided herein. Further, some of the steps may be performed simultaneously, or in a different order than shown in FIG. 6.

At step 610, a turning wheel 30 is fitted on a half circle notch 22 on a base plate 20 onto which the prism lens 10 is to be placed. In some embodiments, turning wheel 30 may include a cap that can be rotated/turned by a user and a tail 32.

At step 620, a spring 40 is fitted on a tail 32 of the turning wheel 30.

At step 630, the prism lens 10 is placed onto the base plate 20. In some embodiments, the prism lens 10 may be fixed to the prism lens holder 50 first and then placed onto the base plate 20 along with the prism lens holder 50. In some other embodiments, the prism lens holder 50 may be formed as an integral part of the base plate 20, and the prism lens 10 is fixed to the prism lens holder 50 which is already on the base plate 20. As an example, the prism lens 10 may be glued to the prism lens holder 50.

In some embodiments, placement of the prism lens 10 may be guided by at least one guiding pin 24 attached on the base plate 20. Optionally, a cover plate 60 may be provided and the cover plate 60 may be fitted on the base plate 20 with screws 70. The cover plate 60 along with the at least one guiding pin 24 on the base plate 20 may help for the placement and positioning of the prism lens 10 or the prism lens 10 together with the prism lens holder 50.

At step 640, the turning wheel 30 is turned until it engages with the prism lens 10 or the prism lens holder 50 on which the prism lens is fixed. Turning the turning wheel 30 moves tail 32 towards prism lens holder 50. In some embodiments, turning wheel 30 is considered to “engage” the prism lens holder 50 when tail 32 is threaded into threaded hole 52 of prism lens holder 50 and spring 40 starts to compress.

At step 650, the turning wheel 30 is fine adjusted to move the prism lens 10 to a target location. In some embodiments, the target location is a location of the prism lens 10 that enables the prism lens 10 to focus the light beams 2 onto a desired object, such as sensor 7. Turning the cap of turning wheel 30 moves tail 32 inward of threaded hole 52, which compresses spring 40 and in turn pushes prism lens holder 50 forward. That way, the location of prism lens holder 50 with the prism lens 10 fixed thereon is adjusted in response to turning of turning wheel 30. In some embodiments, the precision of the adjustment is determined by the turning ratio of turning wheel 30. By using a smaller turning ratio (i.e., displacement per turn), the location of the prism lens may be adjusted with a higher precision.

At step 660, the prism lens 10 is secured at the target location. In some embodiments, prism lens 10 may be secured at the target location by applying filler 80 in gaps between the prism lens holder 50 and the base plate 20 and the cover plate 60. In some embodiments, filler 80 may be a non-rigid material between solid and liquid states, e.g., glue, and/or a material with a low coefficient of thermal expansion, in order to ensure prism lens holder 50 stays in place relative to base plate 20.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A method of adjusting a prism lens in a LiDAR system in which the prism lens focuses light on a MEMS sensor, comprising:
fitting a turning wheel on a half circle notch on a base plate onto which the prism lens is to be placed;
fitting a spring on a tail of the turning wheel;
placing the prism lens onto the base plate;
turning the turning wheel until it engages with the prism lens;
fine adjusting the turning wheel to move the prism lens to a target location; and
securing the prism lens at the target location.

2. The method of claim 1, further comprising:
fixing the prism lens to a prism lens holder.

3. The method of claim 2, wherein the prism lens is glued to the prism lens holder.

4. The method of claim 2, wherein the prism lens is placed onto the base plate together with the prism lens holder.

5. The method of claim 2, wherein the prism lens holder is part of the base plate.

6. The method of claim 4, wherein the prism lens and the prism lens holder are placed onto the base plate using at least one guiding pin attached on the base plate as guidance.

7. The method of claim 6, further comprising:
fitting a cover plate on the base plate.

8. The method of claim 7, wherein the cover plate is fitted on the base plate with screws.

9. The method of claim 7, wherein the prism lens holder is positioned by the at least one guiding pin and the cover plate.

10. The method of claim 1, wherein the target location of the prism lens enables the prism lens to focus light onto a sensor.

11. The method of claim 7, wherein the prism lens is secured at the target location by applying glues in gaps between the prism lens holder and the base plate and the cover plate.

12. A system of adjusting a prism lens in a LiDAR system in which the prism lens focuses light on a MEMS sensor, comprising:
a base plate;
a prism lens placed onto the base plate;
a turning wheel being fitted on a half circle notch on the base plate; and
a spring being fitted on a tail of the turning wheel,
wherein the turning wheel is configured to fine adjust the prism lens to a target location that enables the prism lens to focus the light onto the MEMS sensor.

13. The system of claim 12, further comprising:
a prism lens holder, the prism lens being fixed to the prism lens holder.

14. The system of claim 13, wherein the prism lens is glued to the prism lens holder.

15. The system of claim 13, wherein the prism lens is placed onto the base plate together with the prism lens holder.

16. The system of claim 13, wherein the prism lens holder is part of the base plate.

17. The system of claim 13, wherein the base plate further includes at least one guiding pin attached thereon for guiding the placement of the prism lens and the prism lens holder onto the base plate.

18. The system of claim 17, further comprising a cover plate fitted onto the base plate with screws,
wherein the prism lens holder is positioned by the at least one guiding pin and the cover plate.

19. The system of claim 18, wherein the prism lens is secured at the target location by applying glues in gaps between the prism lens holder and the base plate and the cover plate.

20. A LiDAR system, comprising:
a MEMS sensor;
a prism lens focusing light on the MEMS sensor; and
a system of adjusting a location of the prism lens, including:
a base plate, the prism lens being placed onto the base plate;
a turning wheel being fitted on a half circle notch on the base plate; and
a spring being fitted on a tail of the turning wheel,
wherein the turning wheel is configured to fine adjust the prism lens to a target location that enables the prism lens to focus the light onto the MEMS sensor.
